(19) United States
(12) Patent Application Publication
(10) Pub. No.: US 2020/0070888 A1
(43) Pub. Date: Mar. 5, 2020

(54) METHOD AND PRODUCT FOR HANDLING DRIVER INTERVENTION IN AN AUTONOMOUS STEERING SYSTEM

(71) Applicants: Steering Solutions IP Holding Corporation, Auburn Hills, MI (US); Continental Automotive Systems, Inc., Auburn Hills, MI (US)

(72) Inventors: Scott A. Millsap, Grand Blanc, MI (US); Joseph A. Labarbera, Birch Run, MI (US); Scott T. Sanford, Swartz Creek, MI (US)

(21) Appl. No.: 16/553,803

(22) Filed: Aug. 28, 2019

Related U.S. Application Data
(60) Provisional application No. 62/725,878, filed on Aug. 31, 2018.

(51) Int. Cl. B62D 15/02; B62D 6/04; B62D 6/00

(52) U.S. Cl. CPC B62D 15/025; G05D 1/0088; B62D 6/008; B62D 6/04

(57) ABSTRACT

In a number of illustrative variations, an autonomous steering system may comprise a number of logic modules intended to autonomously address a number of areas of control within the realm of vehicle steering and travel including but not limited to vehicle acceleration, vehicle braking, and lateral control of the vehicle. The logic for the modules of the autonomous steering system may account for driver assistance or intervention.

This application claims the benefit of U.S. Provisional Application Ser. No. 62/725,878 filed Aug. 31, 2018.

### TECHNICAL FIELD

The field to which the disclosure generally relates to includes steering systems.

### BACKGROUND

Vehicles typically include steering systems.

### SUMMARY OF ILLUSTRATIVE VARIATIONS

A number of illustrative variations may include a method or product for handling driver intervention in an autonomous steering system.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts an illustrative variation in which an autonomous steering system, that allows driver intervention or cooperation, guides a car down a path and a driver intervenes in or cooperates with the autonomous steering system.

FIG. 2 depicts an illustrative variation in which an autonomous steering system that allows driver intervention or cooperation is implemented in a steer-by-wire steering system.

FIG. 3 depicts an illustrative variation in which an autonomous steering system that allows driver intervention or cooperation is implemented in an electric power steering system.

FIG. 4 depicts an illustrative variation in which an autonomous steering system provides intuitive visual and tactile steering feedback to a driver by balancing autonomous inputs and driver inputs according to state-based logic.

### DETAILED DESCRIPTION OF ILLUSTRATIVE VARIATIONS

The following description of the variations is merely illustrative in nature and is in no way intended to limit the scope of the invention, its application, or uses.

In a number of illustrative variations, a vehicle for cargo or passengers may be driven ahead by an automotive power derived from a motor that transforms a source of stored energy into a driving force for the vehicle such as but not limited to an internal combustion engine, a battery powered engine, a fuel-cell powered engine, or any other known motor for providing automotive driving power for a passenger or cargo vehicle. The driving force that results from the transformation of stored energy by the motor may be communicated from the motor to a driving medium along which the vehicle will travel such as but not limited to a tract of land, a road, a waterway, an airway, or any other medium along which vehicles are known to travel through space. The communication of the driving force from the motor to the driving medium may occur via any means of driven automotive vehicle movement such as but not limited to roadwheels, treads, casters, rollers, propellers, gas thrusters, liquid thrusters, or ion driven thrusters, or any other known means of driven automotive vehicle movement.

As used herein, “wheels” or “wheel,” even when modified by a descriptive adjective such as but not limited to in the recitation of “steerable roadwheels,” “steerable wheels,” “road wheels,” or “driven wheels,” may refer to a traditional road wheel and tire arrangement, but may also refer to any modification to the traditional road wheel and tire arrangement such as but not limited to rimless mag-lev tires, ball tires, or any other known means of automotive movement such as but not limited to treads, casters, rollers, propellers, or gas thrusters, liquid thrusters, or ion driven thrusters.

As used herein, “road,” even when modified by a descriptive adjective may refer to a traditional driving surface road such as but not limited to a concrete or asphalt road but may also refer to any driving surface or medium along which or through which a vehicle for cargo or passengers may travel such as but not limited to water, ice, snow, dirt, mud, air or other gases, or space in general.

In a number of illustrative variations, a vehicle may have a steering system that allows a driver to change the vehicle's direction or divert it from a path that it may be traveling in. This steering system may operate in conjunction with a source of driven automotive vehicle movement such as a pair of driven roadwheels. As a non-limiting example, a vehicle may be equipped with an internal combustion engine that mechanically drives a pair of rear roadwheels to propel the vehicle forward along a road. In such an example, the vehicle may additionally equipped with a set of steerable front roadwheels that may be manipulated by the steering system via a steering interface such as but not limited to a handwheel to steer the vehicle to the left and to the right as the vehicle travels down the road. In such an example, the driven rear roadwheels serve as the means of driven automotive vehicle movement, and the steerable pair of front roadwheels as manipulated by the steering interface serves as the steering system. Importantly, this is not the only means by which a vehicle is contemplated as being driven or steered in this disclosure. Indeed, in a number illustrative variations the front roadwheels may be the driven roadwheels as well as the steerable roadwheels. Similarly, the means of driven automotive vehicle movement does not need to be of the same kind as the steering means. That is, if the means of driven automotive vehicle movement comprises roadwheels, the steering means does not need to also comprise roadwheels. To that end, as a non-limiting example, it is contemplated that a snowmobile may be driven by a set of treads toward the rear of the vehicle and steered by a set of steerable skis toward the front of the vehicle. Additionally, it is contemplated that the means of driven automotive vehicle movement, such as but not limited to driven roadwheels, and the steering means, such as but not limited to steerable roadwheels, may change function or oscillate in function while in operation. As a non-limiting example, a vehicle comprising a pair of driven roadwheels near the rear of the vehicle and further comprising a pair of steerable roadwheels near the front of the vehicle may change driving modes and begin to utilize every roadwheel available, including the front steerable roadwheels, as driven roadwheels while still maintaining the steerable property and steering function of the front steerable roadwheels. It is similarly contemplated that driven roadwheels may be intermittently or optionally used as steerable roadwheels in some cases.

In a number of illustrative variations, a vehicle's steering system may also be autonomous in that the vehicle may steer itself toward a predetermined location that has been communicated to it without assistance or interference from a driver. The vehicle may have an obstacle avoidance system that allows the vehicle to sense objects in its path and avoid them. In some cases, the driver of the vehicle may wish to assist the vehicle in avoiding an object, or to change direction of the vehicle without first communicating that wish to the vehicle in some other manner. In such a case, the driver may take control of the driver-side steering system controls and assist the autonomous steering system. In such a case, haptic feedback indicating the autonomous system's steering intent as well as any normal steering forces may be communicated to the driver via any interface through which the driver may use to communicate a driver steering intent to the steering system.

In a number of illustrative variations, an autonomous driving system may be programmed with any number of logic modules arranged to autonomously address a number of areas of control within the realm of vehicle steering and travel including but not limited to vehicle acceleration, vehicle braking, and an autonomous steering system for at least lateral control of the vehicle. The logic for the modules of the autonomous steering system may account for driver assistance or intervention.

In a number of illustrative variations, in order to foster a cooperative steering system, the sensors of an autonomous steering system may be configured to detect and identify steering input as driver input. The logic of the autonomous steering modules may also be configured to average, balance, or blend input identified as driver steering input with the autonomous system's steering input, thereby acting as a cooperative steering system.

In a number of illustrative variations, the logic of any autonomous steering module may assign a first weight to autonomous input and a second weight to driver input. The first weight may be called autonomous authority, and the second weight may be called driver authority. In some cases, full steering control may be relinquished to the driver if the driver authority reaches a certain threshold. In some such cases, the relinquishment of control to the driver is indicated to the driver via a driver notification even such as but not limited to the updating of a display or a notification via a manipulation of a steering interface such as but not limited to a vibrating of a handwheel. Driver authority may be determined or affected by an algorithm that may be designed to determine and weigh driver intent. In some cases, full steering control may be reserved solely to the autonomous input if the steering system or some other system presiding over the steering system determines that driver input should not be given precedent or adjudges that driver authority should be low or denied. As a non-limiting example, the autonomous input may be given sole control of the steering system, to the exclusion of driver input, in a situation in which it is determined by autonomous steering modules that the driver would very likely be making a catastrophic error if allowed to steer in the direction that the driver is attempting to steer. As another non-limiting example, such a denial of driver authority could arise if the sensors of the autonomous vehicle determine that the driver is attempting to merge, but merging would result in a collision. As yet another non-limiting example, driver control could be denied if a system monitoring traffic in general determined that merging would cause a collision and communicated that determination to the autonomous vehicle.

In a number of illustrative variations, forces respondent to, involved in, or resulting from steering may be communicated to the driver via any interface used for steering as a form of force feedback that may be helpful to the driver in steering the vehicle. These forces may include but may not be limited to cornering force, centrifugal force or any other road forces or rack forces.

In a number of illustrative variations, a vehicle may comprise a steering system comprising a steering interface, and a set of steerable roadwheels. The steering system may be of the electric power steering type wherein physical linkages mechanically communicate a manipulation of the steering interface to the steerable wheels. The steering system may be of the steer-by-wire type wherein physical mechanisms do not mechanically communicate a manipulation of the steering interface to the steerable roadwheels and wherein a manipulation of the steering interface affects an associated manipulation of the steerable roadwheels via the communication of electronic devices such as but not limited to sensors, transceivers and electronically excited actuators.

In a number of illustrative variations, a steering ratio is defined as the ratio describing a relationship between the affectation of a steering interface to the affectation of a steering device. As a non-limiting example, a steering ratio for a boat may be defined as the ratio relating how far a rudder of the boat turns in response to a rotation of a captain's wheel. As another non-limiting example, a steering ratio for an aircraft may be defined as a ratio relating how far an aileron of the aircraft raises or lowers in response to a turning of a pilot's control wheel. As yet another non-limiting example, a steering ratio for a wheeled vehicle may be defined as a ratio relating how far a vehicle's steerable roadwheels turn in response to a turning of a handwheel.

In a number of illustrative variations, if a vehicle comprises an electronic power steering system. In such a case, the steering interface mechanically communicates with any mechanism used to steer the vehicle according to a steering ratio. Thus, if a vehicle comprising an electronic power steering system comprises fully autonomous steering or semi-autonomous steering that allows driver cooperation or intervention, the steering system may communicate force feedback from steering on any interface by which the driver may steer the vehicle. As a non-limiting example, when engaged in fully autonomous steering, a vehicle may automatically rotate a vehicle's handwheel in conjunction with the autonomous steering system turning the vehicle's steerable roadwheels such that a non-intervening or non-cooperating driver may associate the automatic turning of the vehicle's handwheel with the turning of the vehicle's steerable roadwheels and intuit, surmise, or estimate a steering ratio. Thus, if the driver desires to cooperate or intervene in the automated steering, the driver may be less disoriented when attempting to commandeer a steering interface that seems to be unassociated or misaligned with the vehicle's steerable roadwheels.

In a number of illustrative variations, any autonomous manipulation of any steering interface may be controlled by the autonomous steering system in order to make the driving and riding experience more comfortable and intuitive to a driver during any transition to or from autonomous driving, cooperative driving, or entirely driver-controlled driving modes. In such illustrative variations, an autonomous manipulation of the steering interface may act as visual steering feedback that allows the driver to intuit or surmise the steering commands being communicated to and interpreted by the autonomous steering system and how those commands affect the steering of the vehicle via a concurrent, associated, autonomous manipulation of the steering interface. To further facilitate the intuitive driving and riding experience for the driver, autonomous steering commands may be interpreted by the systems affecting the autonomous manipulation of the steering interface in a manner intended to be particularly amenable, palatable, or ergonomic to a human driver. As a non-limiting example, a damping factor may be applied to any raw steering interface position command or force command in order to slow any manipulation of the steering interface when and manipulation of the steering interface by the driver ceases, as well as to control the timing of the adjustment of the position and force applied by the steering system to the steering interface via a steering interface manipulation device so that the steering interface's manipulation is in sync with the vehicle's motion. In this way, the driver may be more likely to find comfort along in an autonomously steered vehicle if the visual steering feedback provided to the steering interface by the autonomous steering system seems less jerky, robotic, or inhuman and thus less disconcerting to any human observer.

In a number of illustrative variations, if a vehicle comprises a steer-by-wire steering system, it may be necessary for force feedback from steering to be simulated for the driver in order to deliver an intuitive, semi-autonomous steering experience for the driver. If a vehicle comprising a steer-by-wire steering system comprises fully autonomous steering or semi-autonomous steering that allows driver cooperation or intervention, the steering system may simulate feedback from steering on any interface by which the driver may steer the vehicle. As a non-limiting example, when engaged in fully autonomous steering, the vehicle may automatically rotate a vehicle's handwheel in conjunction with the autonomous steering system turning the vehicle's steerable roadwheels such that a non-intervening or non-cooperating driver may associate the automatic turning of the vehicle's handwheel with the turning of the vehicle's steerable roadwheels and intuit, surmise, or estimate a steering ratio. Thus, if the driver desires to cooperate or intervene in the automated steering, the driver may be less disoriented when attempting to commandeer a steering interface that seems to be unassociated or misaligned with the vehicle's steerable roadwheels. In some such cases, the steering interface may be automatically manipulated by the autonomous steering system and simulate force feedback to the driver to simulate steering forces by use of electric or mechanical motors, actuators, magnets, or any other method known in the art.

In a number of illustrative variations, while the vehicle is steering autonomously, the driver may attempt to cooperate or intervene in steering the vehicle. In some such cases, upon determining driver authority, the steering system may allow the driver to intervene or cooperate in steering the vehicle while also determining the amount or level of variance to the autonomous steering that the driver is applying. In such cases, the autonomous steering system may calculate the variation to the vehicle travel direction or path as well and may continuously calculate new vehicle travel directions or paths as the driver intervenes such that if the driver stops intervening, the vehicle may begin autonomously steering according to one of the new travel directions or paths.

In a number of illustrative variations, while the vehicle is steering autonomously according to a predetermined vehicle path, if the driver attempts to divert the travel of the vehicle from the predetermined path by manipulating a steering interface of the vehicle in an attempt to steer the vehicle, the autonomous steering system may provide feedback to the steering interface with an intensity or frequency related to the manner or amount of attempted deviation from the predetermined vehicle path. As a non-limiting example, if the autonomous steering system is steering on a straight-forward bearing in a particular lane in accordance with a predetermined vehicle path, and the driver intervenes by attempting to steer the vehicle away from the straightforward bearing by applying force to a steering interface, the autonomous steering system may apply a counteractive force to the same steering interface in opposition to the driver's force input as a way of indicating to the driver that the driver is attempting to divert the vehicle from the predetermined path on which it is autonomously driving. The counteractive force applied against the driver's input force may be roughly proportional to the force applied to the steering interface by the driver or may increase or decrease in intensity as a function of the magnitude of diversion from the predetermined path that is being caused by the driver.

In a number of illustrative variations, a handwheel serves as the steering interface for an autonomous steering system for a vehicle comprising steerable roadwheels. In some such variations, if the driver intervenes or cooperates in steering, any mechanism used to automatically rotate the vehicle's handwheel in conjunction with the autonomous steering system turning the vehicle's steerable roadwheels may require the driver to apply steering effort with it or against it as the autonomous steering system simultaneously continues to steer the vehicle. In some cases, the autonomous steering system may blend the driver input with the autonomous steering input as a manner of determining a net steering input and utilize the net steering input as a control signal for any turning of the steerable roadwheels and associated force feedback for the steering interface such as but not limited to an automatic turning of a handwheel. As a non-limiting example, if a driver takes hold of a handwheel of a vehicle while the vehicle is in autonomous steering mode, the autonomous steering system may continue to simultaneously steer the vehicle and may indicate its intent to steer to the right to the driver by rotating the handwheel to the right in conjunction with turning the steerable roadwheels of the vehicle to the right, however, while the driver still has hold of the handwheel, the driver may sense this attempt to turn right by the autonomous system and may choose to intervene by augmenting the amount of the turn. In some such cases, if the driver attempts to stop the handwheel from turning right, the autonomous steering system will sense this and infer a driver intent from this. The autonomous steering system may adjudge driver authority based at least upon the inferred driver intent, and either allow or disallow the driver to intervene in the steering. As a non-limiting example of when the autonomous system allows a driver to intervene, in some such cases the autonomous system may greatly reduce but not eliminate the amount of force it is applying to the handwheel as a component of the autonomous steering system, thereby making it easy for the driver to commandeer the vehicle without giving the driver the impression that the autonomous steering system has completely relinquished control to the driver. In this way, the driver may be assured that the autonomous steering system is still attempting to control the vehicle and will return to controlling the vehicle after the driver releases the handwheel. As another non-limiting example of when the autonomous system allows a driver to intervene, in some such cases the autonomous system may completely eliminate the amount of force it is applying to the handwheel as a component of the autonomous steering system, thereby making easy for the driver to commandeer the vehicle and additionally indicating to the driver that the autonomous steering system has completely relinquished control to the driver. In some such cases, the driver may be thereby notified that the autonomous steering system is disabled and no longer attempting to control the vehicle. Additionally, in such cases, the driver may thereby be notified that the steering system will not return to controlling the vehicle after the driver releases the handwheel unless the autonomous steering is re-enabled.

In a number of illustrative variations, if the vehicle is steering autonomously and without driver intervention or cooperation, and the driver attempts to intervene or cooperate in steering, the steering system may determine that the driver authority is low or should be low or denied, the steering system may ignore any attempt by the driver to steer and instead steer the vehicle in ignorance of the driver input. As a non-limiting example, in the case of a steer-by-wire system, in the event that the vehicle sensors and systems, or any other system informing the vehicle determines that a steering maneuver is mandatory for safety reasons, the vehicle may ignore driver input and perform the steering maneuver autonomously, regardless of driver input.

In a number of illustrative variations, if the driver attempts to intervene or cooperate in steering via the steering interface, the steering system may attempt to oppose the driver input by generating opposing autonomous input to manipulate the steering interface in an opposing manner to the driver input. In some such cases, the steering system may set a threshold for torque or force that it may apply to the steering interface in opposition to the driver. If the driver overpowers the torque or force resulting from the opposing autonomous input, the autonomous steering system may relinquish control of the steering system to the driver.

In a number of illustrative variations, the steering interface and the steerable roadwheels may appear to become misaligned or seem to have become disassociated from the perspective of a driver of the vehicle. In such a case, it may be necessary to realign and associate the steering interface with the steerable roadwheels. As a non-limiting example, the steering system may accomplish this alignment or association by adjusting the steering ratio so that the driver may naturally align the steering interface with the steerable roadwheels over the course of future steering maneuvers initiated by the driver. As another non-limiting example the steering system may accomplish this alignment or association by maintaining the apparent misalignment until the driver relinquishes full control to the autonomous steering system, after which the steering system may perform the realignment and association.

In a number of illustrative variations, the steering interface may comprise a joystick, a trackball, a slider, a throttle, a pushbutton, a toggle switch, a lever, a touchscreen, a mouse, or any other known means of user input. In cases where driver input is via a driver interface that yields no obvious opportunity for force feedback, such as but not limited to variations involving a mouse or touchscreen as a primary means of driver input, the automated steering system may indicate resistance to driver input via visual cues such as but not limited to a flash or an animation on a display, audio cues such as but not limited to clicks, beeps, or an instructive voice recording, generated voice, or live voice, or haptic cues such as but not limited to vibration of a screen, or any other cue that may indicate to the driver how driver input—which may be concurrent with autonomous input—is being opposed, cooperated with, integrated or handled by the steering system.

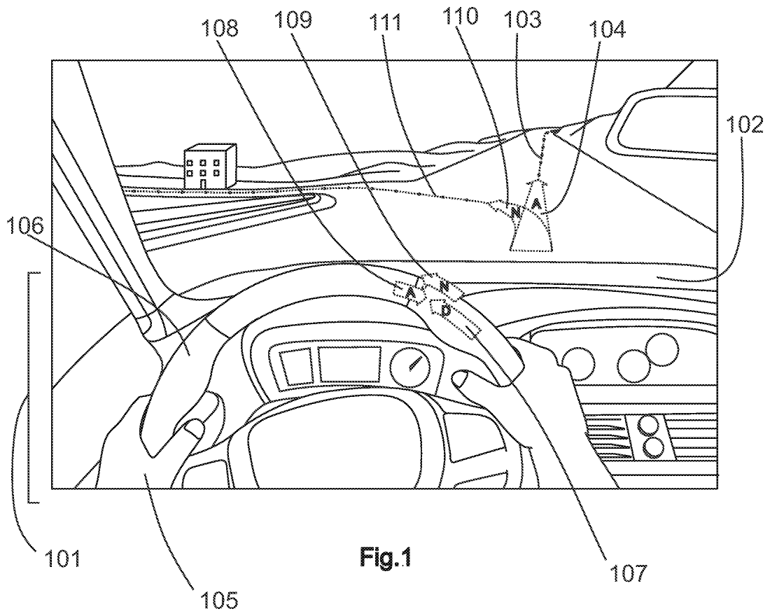

Referring now to FIG. 1, an illustrative variation in which an autonomous steering system 101 is steering a vehicle 102 on a first autonomous path 103 in a first direction 104 when a driver 105 attempts to intervene by engaging the steering interface 106. In this variation, the autonomous steering system 101 determines that the driver's 105 authority is sufficient to allow the driver 105 to intervene in steering, and the autonomous steering system 101 blends the driver's steering input 107 with autonomous steering input 108 on the steering interface 106 to form a net steering input 109 that sends the vehicle 102 in a second direction 110, for which the autonomous steering system 101 determines a second autonomous path 111.

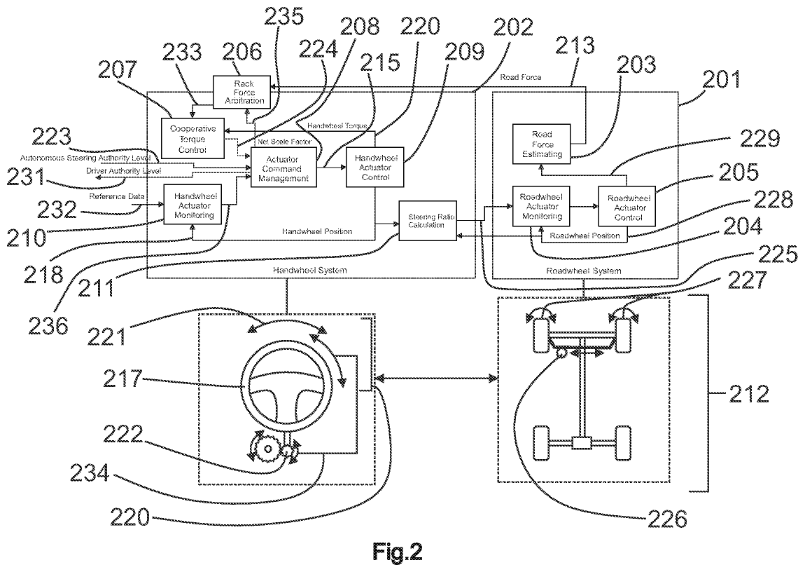

Referring now to FIG. 2, a flow diagram for an illustrative variation of a cooperative steering algorithm for an autonomous steering system having a steer-by-wire configuration is shown. An autonomous steering system may comprise a roadwheel system 201 and a handwheel system 202. The roadwheel system 201 may comprise a road force estimating module 203, a roadwheel actuator control module 205, and a roadwheel actuator monitoring module 204. The handwheel system 202 may comprise a rack force arbitration module 206, a cooperative torque control module 207, an actuator command management module 208, a handwheel actuator control module 209, a handwheel actuator monitoring module 210, and a steering ratio calculation module 211. While a vehicle 212 is being steered, road forces 213 may be estimated by the road force estimating module 203 of the roadwheel system 201. These forces may be communicated by the road force estimating module 203 to the rack force arbitration module 206 of the handwheel system 202. While in autonomous driving mode, a handwheel actuator control module 209 may receive a command to manipulate a handwheel actuator 222. The handwheel actuator control module 209 may receive this command in the form of a weighted actuator command 215 generated by the actuator command management module 208 in light of information received from the cooperative torque control module 207 and from the handwheel actuator monitoring module 210. The handwheel actuator control module 209 may interpret the weighted actuator command 215 and cause a handwheel actuator 222 to rotate a handwheel 217 to a specified handwheel position with a specified handwheel torque. At any time, the rack force arbitration module 206 may process any road forces 213 communicated to it by the road force estimating module 203 in light of a net scale factor 235 generated by the actuator command management module 208 and feed the result of this process back to the cooperative torque control module 207. The net scale factor 235 may inform the type or magnitude of force feedback that is desirable to communicate to a driver via the handwheel 217 based upon whether driver input 221 or autonomous input 234 is in primary control of the handwheel 217. The cooperative torque control module 207 may also receive data about any changes to the handwheel torque 220, whether by driver input 221 or by autonomous input 234, via the handwheel actuator control module 209. All of this may be processed by the cooperative torque module 207 with the purpose of simulating genuine mechanical force feedback on the handwheel 217 via the handwheel actuator 222, but any weighted actuator command 215 communicated to the handwheel actuator control module 209 for the purpose of simulating force feedback to the handwheel 217 via the handwheel actuator 222 may be first communicated by the cooperative torque control module 207 as an unweighted actuator command 224 to the actuator command management module 208 so that the unweighted actuator command 224 may be weighted in light of a driver authority level 231 being weighed against an autonomous steering authority level 223 to produce a weighted actuator command 215. Once produced by the actuator command management module 208, the weighted actuator command 215 may be communicated to the handwheel actuator control module 209 which may induce the handwheel actuator 222 to rotate the handwheel 217, and which may induce the handwheel actuator control module 209 to also communicate: the resultant handwheel torque 220 to the cooperative torque control module 207 for future calculations; the resultant handwheel position data 218 to the steering ratio calculation module 211 so that a corresponding steering ratio 225 may be calculated; and, the resultant handwheel position data 218 to the handwheel actuator monitoring module 210 so that the handwheel actuator monitoring module 210 may, where necessary, generate and communicate a corrective handwheel actuator command 236 as an autonomous input to the actuator command management module 208 such that the handwheel 217 may accurately simulate force feedback via a proper adjustment of the handwheel actuator 222 as verified against reference data 232. In conjunction with this, the steering ratio calculation module 211 may generate and communicate a corresponding steering ratio signal 225 to the roadwheel actuator monitoring module 204 and to the roadwheel actuator control module 205 so that the adjustment of the handwheel actuator 222 and an adjustment of the roadwheel actuator 226 may occur in alongside one another. The roadwheel actuator monitoring module 204 may monitor the positions of the roadwheels 227 as a result of this adjustment, and may communicate a corrective roadwheel actuator command to the roadwheel actuator control module 205 to further adjust the roadwheel actuator 226. The roadwheel actuator control module 205 may also communicate an adjustment feedback signal 228 to the steering ratio calculation module 211—for producing an updated steering ratio calculation—and the roadwheel actuator monitoring module 204—for producing a new roadwheel actuator command—as well as communicating a roadwheel actuator position signal 229 to the road force estimating module 203 for its calculations and communication with the rack force arbitration module 206, as described above.

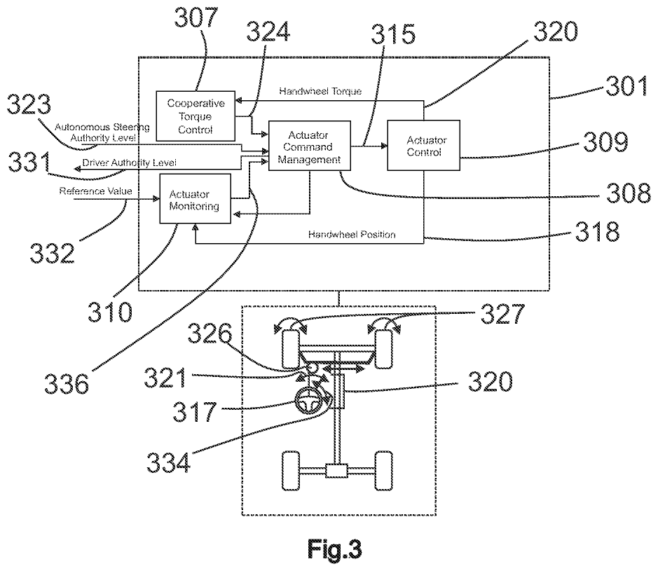

Referring now to FIG. 3, a flow diagram for an illustrative variation of a cooperative steering algorithm for an autonomous steering system having an electronic power steering configuration is shown. An autonomous steering system may comprise a roadwheel and handwheel system 301. The roadwheel and handwheel system 301 may comprise a cooperative torque control module 307, an electronic power steering actuator command management module 308, an electronic power steering actuator control module 309, and an electronic power steering actuator monitoring module 310. While in autonomous driving mode, the electronic power steering actuator control module 309 may receive a weighted actuator command 315 generated by the electronic power steering actuator command management module 308 in light of information received from both the cooperative torque control module 307, the electronic power steering actuator monitoring module 310, a driver authority level 321 and an autonomous steering authority level 323. The electronic power steering actuator control module 309 may interpret the weighted actuator command 315 and may cause an electronic power steering actuator 326 to rotate a handwheel 317 in conjunction with an associated turning of a set of roadwheels 327. The electronic power steering actuator control module 309 may also communicate: a resultant handwheel torque 320 to the cooperative torque control module 307 for future calculations; and, a resultant handwheel position 318 to the electronic power steering actuator monitoring module 310 so that the handwheel 317 and roadwheels 327 may accurately turn, as verified against a reference value 332 and so that, where necessary, the electronic power steering monitoring module 310 may generate and communicate a corrective actuator command 336 as autonomous input to the electronic power steering actuator command management module 308 so that the handwheel 317 may accurately simulate force feedback and so that the roadwheels 327 may be accurately adjusted via a proper adjustment of the electronic power steering actuator 326. At any time, the electronic power steering actuator control module 309 may sense changes to handwheel torque 320, whether by a driver input 321 or by autonomous input 334 via the electronic power steering actuator 326, and communicate this change in handwheel torque 320 to the cooperative torque control module 307. All of this may be processed by the cooperative torque control module 307 with the purpose of balancing driver input 321 with autonomous input 334 via weighted actuator commands 315 generated and communicated to the electronic power steering actuator control module 309 by the electronic power steering actuator command management module 308. Any weighted actuator command 315 communicated to the electronic power steering actuator control module 309 may be first communicated by the cooperative torque control module 307 as an unweighted actuator command 324 to the electronic power steering command management module 308 so that the unweighted actuator command 324 may be weighted in light of a driver authority level 331 being weighed against an autonomous steering authority level 323 to produce a weighted actuator command 315. Once produced by the electronic power steering actuator command management module 308, the weighted actuator command 315 may be communicated to the electronic power steering actuator control module 309 which may induce the electronic power steering actuator 326 to rotate. The electronic power steering monitoring module 310 may correlate the resultant handwheel position 318 to the reference value 332, and may communicate any discrepancies, to the electronic power steering actuator command management module 308 for processing according to the method described above.

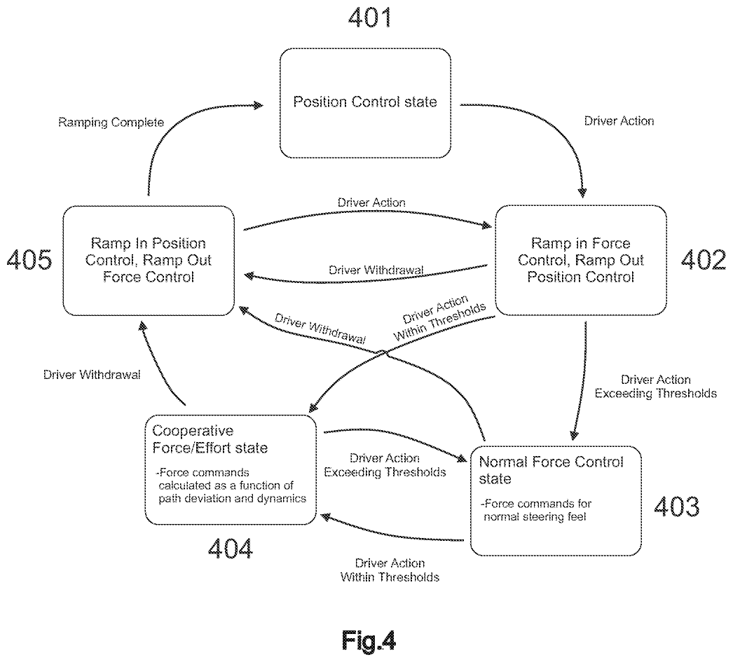

Referring now to FIG. 4, a state diagram for an illustrative variation of a cooperative steering algorithm for an autonomous steering system wherein states of feedback to the steering interface are traversed seamlessly. In such an illustrative variation, autonomous manipulation and feedback of the steering interface of the autonomous steering system may be controlled by a steering interface on the basis at least one of position commands or force commands such as but not limited to torque commands to a handwheel. In state 401, the vehicle is steering autonomously and any autonomous manipulation of the steering interface by the autonomous steering system may be based solely on position commands for the sake of providing a driver with intuitive visual feedback via an autonomous manipulation of the steering interface based upon the position commands. When the driver wishes to intervene or cooperate in steering, the driver may attempt to manipulate the steering interface himself or herself. In such a case, the driver's interaction with the steering interface may be detected by the autonomous steering system, such as but not limited to the detection of hands on a handwheel, a tool on a touchscreen, manipulation of a slider, and so on, and a transition state 402 may be entered. In transition state 402, the steering interface may ramp into being controlled primarily by force commands and ramp out of being controlled by primarily position commands so that the driver experiences a seamless transition from intuitive visual feedback to intuitive force feedback upon commandeering the steering interface. In some circumstances, such as but not limited to when the driver shows intent to fully commandeer the vehicle by exceeding a monitored vehicle yaw rate threshold or steering interface manipulation rate threshold, state 403 may be ramped into directly from state 402. In state 403, the steering interface may manipulated by the autonomous steering system primarily or solely by force commands in order to provide full force feedback to the driver in order to communicate a normal, intuitive steering feel to the driver while the driver is steering the vehicle without the steering aid of the autonomous steering system. In other circumstances, state 404 may be ramped into directly from state 402. State 404 may be transitioned to when the autonomous steering system senses the driver's intent to cooperate or intervene in the autonomous steering system's current steering prerogative but does not intend to fully commandeer the vehicle for the purpose of continuous or prolonged driver-directed steering. This driver intent may be sensed in circumstance such as but not limited to when the driver manipulates the steering interface, but only to an extent that does not surpass a threshold criteria such as causing the steering interface to exceed a threshold rate of change or causing the vehicle to exceed a threshold yaw rate. Transition state 405 may be when the autonomous driving system detects that the driver intends to relinquish control of the vehicle back to the autonomous steering system by ceasing to manipulate the steering interface, such as but not limited to removing his or her hands from a handwheel, removing a tool from a touchscreen, removing fingers from sliders, etc. In transition state 405, the autonomous steering system may ramp back into controlling the manipulation of the steering interface primarily by the use of position commands and ramp out of controlling the manipulation of the steering interface by force commands in order to once again give the driver or rider intuitive visual feedback about the autonomous steering of the vehicle via an induced manipulation of the steering interface. From transition state 405, state 401 may be once again entered, and the vehicle may be steered entirely by the autonomous steering system, with intuitive visual feedback being communicated to the driver or rider via the steering interface which may now be primarily controlled by position commands. It is worth noting that, in this illustrative variation, generally, transitions between states must occur via a transition state. However, transitions between state 403 and 404 may occur without the use of a transition state. State 403 may also transition directly to transition state 405 in a case in which the driver withdraws from attempting to steer the vehicle. Transition state 405 may transition directly to transition state 402 in cases such as but not limited to a quick change of relevant circumstances such as an exceeding of the aforementioned thresholds by driver action. Likewise, Transition state 402 may transition directly to transition state 405 for similar reasons. Also, transition state 402 may transition to state 404 in cases such as but not limited to brief interaction with the steering interface while the autonomous steering system is still in transition state 402.

In a number of illustrative variations, the output of any module based at least upon any sensed autonomously applied torque or other physical phenomena involving autonomously controlled actuators may also be accomplished at least partially by way of estimation in light of received actuator commands, or any other command that urges the automated system to apply such torque or force autonomously.

In a number of illustrative variations, any number of modules may be combined together or broken into smaller modules.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising an autonomous steering system constructed and arranged to concurrently accept and interpret driver steering commands and autonomous steering commands comprising a steering interface.

Variation 2 may include the product variation 1 wherein the product is further configured to induce a manipulation of a steering interface via a steering interface manipulation device as a result of the concurrent accepting and interpreting of driver steering commands and autonomous steering commands.

Variation 3 may include the product of any of variations 1 through 2 wherein the interpreting of driver steering commands and autonomous steering commands comprises blending the autonomous steering command and the driver steering command to produce a net steering command.

Variation 4 may include the product of variation 3 wherein the blending of the autonomous steering command and the driver steering command comprises weighting the driver steering command based at least upon a driver steering authority level before combining the driver steering command with the autonomous steering command.

Variation 5 may include the product of any of variations 3 through 4 wherein the blending of the autonomous steering command with the driver steering command to produce a net steering command further comprises weighting the autonomous steering command based at least upon an autonomous steering authority level before combining the driver steering command with the autonomous steering command.

Variation 6 may include the product of any of variations 4 through 5 wherein, if while weighting the driver input command, the driver authority level reaches a threshold level, the steering interface is manipulated to indicate that the driver authority has reached the threshold level.

Variation 7 may include the product of any of variations 1 through 6 wherein the autonomous steering commands are produced by the autonomous system itself, and wherein when the driver authority level has reached the threshold level, the autonomous system stops producing the autonomous steering commands.

Variation 8 may include a method comprising:

providing an autonomous steering system comprising a steering interface;

providing a steering interface manipulation device;

providing an autonomous steering command;

providing a driver steering command;

blending the autonomous steering command with the driver steering command to produce a net steering command; and,

inducing the steering interface manipulation device to manipulate the steering interface in light of the net steering command.

Variation 9 may include the method of variation 8 wherein the blending of the autonomous steering command with the driver steering command to produce a net steering command comprises weighting the driver steering command based at least upon a driver steering authority level before combining the driver steering command with the autonomous steering command.

Variation 10 may include the method of variation 9 wherein the blending of the autonomous steering command with the driver steering command to produce a net steering command further comprises weighting the autonomous steering command based at least upon an autonomous steering authority level before combining the driver steering command with the autonomous steering command.

Variation 11 may include the method of variation 10 wherein the autonomous steering authority level is determined by the autonomous steering system and is based at least upon contextual data that is sensed by or provided to the autonomous steering system.

Variation 12 may include the method of variation 11 wherein the contextual data comprises road force data.

Variation 13 may include a method of providing steering feedback to a driver via a manipulatable steering interface in an autonomous vehicle during autonomous driving comprising: providing a vehicle comprising an autonomous steering system comprising a manipulatable steering interface configured to be manipulatable by a driver as well as by a steering interface manipulation device, wherein the steering interface manipulation device is configured to manipulate the steering interface to a specified position with a specified amount of force; and, using the autonomous steering system to provide steering feedback to the driver via a manipulation of the steering interface by the steering interface manipulation device.

Variation 14 may include the method of variation 13 wherein manipulation of the steering interface is performed by the steering interface manipulation device with an intensity or frequency related to the manner or amount of an attempt by the driver to deviate the vehicle from a predetermined vehicle path.

Variation 15 may include the method of any of variations 13 or 14 wherein the steering system is further configured to transition between a number of states of manipulation that determine how the steering interface manipulation device manipulates the steering interface, comprising: a first state in which the steering interface is primarily controlled via the steering interface manipulation device by causing the steering interface manipulation device to manipulate the steering interface to the specified position; and, a second state in which the steering interface is primarily controlled via the steering interface manipulation device by causing the steering interface manipulation advice to apply a certain amount of force to the steering interface.

Variation 16 may include the method of variation 15 wherein the first state is utilized only when autonomous steering system is operating in a fully autonomous mode, without the intervention or cooperation of a driver.

Variation 17 may include the method of and of variations 15 or 16 wherein the second state is utilized only when the vehicle is being steered autonomously, and the driver attempts to cooperate or intervene in steering the vehicle.

The above description of select variations within the scope of the invention is merely illustrative in nature and, thus, variations or variants thereof are not to be regarded as a departure from the spirit and scope of the invention.

What is claimed is:

1. A product comprising:
An autonomous steering system constructed and arranged to concurrently accept and interpret driver steering commands and steering commands comprising a steering interface.

2. The product claim 1 wherein the product is further configured to induce a manipulation of a driver steering interface via a steering interface manipulation device as a result of the concurrent accepting and interpreting of driver steering commands and autonomous steering commands.

3. The product of claim 1 wherein the interpreting of driver steering commands and autonomous steering commands comprises blending the autonomous steering command and the driver steering command to produce a net steering command.

4. The product of claim 3 wherein the blending of the autonomous steering command and the driver steering command comprises weighting the driver steering command based at least upon a driver steering authority level before combining the driver steering command with the autonomous steering command.

5. The product of claim 3 wherein the blending of the autonomous steering command with the driver steering command to produce a net steering command further comprises weighting the autonomous steering command based at least upon an autonomous steering authority level before combining the driver steering command with the autonomous steering command.

6. The product of claim 4 wherein, if while weighting the driver input command, the driver authority level reaches a threshold level, the steering interface is manipulated to indicate that the driver authority has reached the threshold level.

7. The product of claim 4 wherein the autonomous steering commands are produced by the autonomous system itself, and wherein when the driver authority level has reached the threshold level, the autonomous system stops producing the autonomous steering commands.

8. A method comprising:
providing an autonomous steering system comprising a steering interface.
providing a steering interface manipulation device.
providing an autonomous steering command;
providing a driver steering command;
blending the autonomous steering command with the driver steering command to produce a net steering command; and,
inducing the steering interface manipulation device to manipulate the steering interface in light of the net steering command.

9. The method of claim 8 wherein the blending of the autonomous steering command with the driver steering command to produce a net steering command comprises weighting the driver steering command based at least upon a driver steering authority level before combining the driver steering command with the autonomous steering command.

10. The method of claim 9 wherein the blending of the autonomous steering command with the driver steering command to produce a net steering command further comprises weighting the autonomous steering command based at least upon an autonomous steering authority level before combining the driver steering command with the autonomous steering command.

11. The method of claim 10 wherein the autonomous steering authority level is determined by the autonomous steering system and is based at least upon contextual data that is sensed by or provided to the autonomous steering system.

12. The method of claim 11 wherein the contextual data comprises road force data.

13. A method of providing steering feedback to a driver via a manipulatable steering interface in an autonomous vehicle during autonomous driving comprising:
providing a vehicle comprising an autonomous steering system comprising a manipulatable steering interface configured to be manipulatable by a driver as well as by a steering interface manipulation device, wherein the steering interface manipulation device is configured to manipulate the steering interface to a specified position with a specified amount of force; and,
using the autonomous steering system to provide steering feedback to the driver via a manipulation of the steering interface by the steering interface manipulation device.

14. The method of claim 13 wherein manipulation of the steering interface is performed by the steering interface manipulation device with an intensity or frequency related to the manner or amount of an attempt by the driver to deviate the vehicle from a predetermined vehicle path.

15. The method of claim 13 wherein the steering system is further configured to transition between a number of states of manipulation that determine how the steering interface manipulation device manipulates the steering interface, comprising:
a first state in which the steering interface is primarily controlled via the steering interface manipulation device by causing the steering interface manipulation device to manipulate the steering interface to the specified position; and,
a second state in which the steering interface is primarily controlled via the steering interface manipulation device by causing the steering interface manipulation advice to apply a certain amount of force to the steering interface;

16. The method of claim 15 wherein the first state is utilized only when autonomous steering system is operating in a fully autonomous mode, without the intervention or cooperation of a driver.

17. The method of claim 15 wherein the second state is utilized only when the vehicle is being steered autonomously, and the driver attempts to cooperate or intervene in steering the vehicle.
